(19) United States
(12) Patent Application Publication
(10) Pub. No.: US 2025/0212131 A1
(43) Pub. Date: Jun. 26, 2025

(54) COORDINATED SPATIAL NULLING (C-SN) FEEDBACK

(71) Applicant: MaxLinear, Inc., Carlsbad, CA (US)

(72) Inventors: Rainer Strobel, München (DE); Avi Avraham Mansour, Givat-Shmuel (IL); Sigurd Schelstraete, Menlo Park, CA (US)

(73) Assignee: MaxLinear, Inc., Carlsbad, CA (US)

(21) Appl. No.: 19/074,246

(22) Filed: Mar. 7, 2025

Related U.S. Application Data
(63) Continuation of application No. 18/829,276, filed on Sep. 9, 2024.
(60) Provisional application No. 63/581,656, filed on Sep. 9, 2023.

(51) Int. Cl. H04W 52/24; H04W 52/36; H04W 74/0816

(52) U.S. Cl. CPC H04W 52/243; H04W 52/367; H04W 74/0816

(57) ABSTRACT

Technology is disclosed for an access point (AP) including a processing device and a transceiver. The processing device may receive, at the AP from a station (STA), information about an interference path between the STA and the AP; select, at the AP, a transmit power based on the information about the interference path between the STA and the AP; and determine, at the AP, a transmission type based on the transmit power, wherein the transmission type comprise one or more of a spatial reuse transmission or a spatial nulling transmission. The transceiver may transmit, from the AP to the STA, a transmission based on the transmission type.

### RELATED APPLICATION

This application is a continuation of U.S. patent application Ser. No. 18/829,276, filed Sep. 9, 2024, which claims the benefit of U.S. Provisional Application No. 63/581,656, filed Sep. 9, 2023, the disclosures of which are incorporated herein by reference in their entireties.

This disclosure relates to wireless communication, and more specifically, to wireless local area network (LAN) latency and throughput improvements by coordinated spatial re-use.

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as 802.11a, 802.11b, 801.11g, 802.11n (Wi-Fi® 4), 802.11ac (Wi-Fi® 5), 802.11ax (Wi-Fi® 6), and so forth.

The subject matter claimed in the present disclosure is not limited to implementations that solve any disadvantages or that operate only in environments such as those described above. Rather, this background is only provided to illustrate one example technology area where some examples described in the present disclosure may be practiced.

### SUMMARY

An access point (AP) may include a processing device and a transceiver. The processing device may receive, at the AP from a station (STA), information about an interference path between the STA and the AP; select, at the AP, a transmit power based on the information about the interference path between the STA and the AP; determine, at the AP, a transmission type based on the transmit power in which the transmission type comprise one or more of a spatial reuse transmission or a spatial nulling transmission. The transceiver may transmit, from the AP to the STA, a transmission based on the transmission type.

A station (STA) may include a processing device and a transceiver. The processing device may receive, at the STA from an access point (AP), a sounding packet in which the AP is not associated with the STA; and compute, at the STA, coordinated spatial re-use (C-SR) feedback. The transceiver may transmit the C-SR feedback to the AP.

A coordination device may include a processing device and a transceiver. The processing device may send, from the coordination device to a first access point (AP), a joint sounding procedure trigger; send, from the coordination device to second AP, the joint sounding procedure trigger; receive, at the coordination device from the first AP, a first sounding feedback from the first AP; receive, at the coordination device from the second AP, a second sounding feedback from the second AP; and determine, at the coordination device, one or more of: a transmit power of one or more of the first AP or the second AP; or a spatial nulling for one or more of the first AP or the second AP.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example of two overlapping wireless local area networks (e.g., basic service sets (BSS).

FIG. 2 illustrates an example of a packet sequence for sounding with coordinated spatial reuse (C-SR) feedback for two access points (APs) and 2 stations (STAs) associated to each AP.

FIG. 3 illustrates an example of the control of the nulling interference reduction.

FIG. 4 illustrates an example of a managed network (e.g., extended service set (ESS) with two BSS and a central coordination device.

FIG. 5 illustrates an example of a managed network (e.g., extended service set (ESS) with two BSS and a central coordination device in one of the access points.

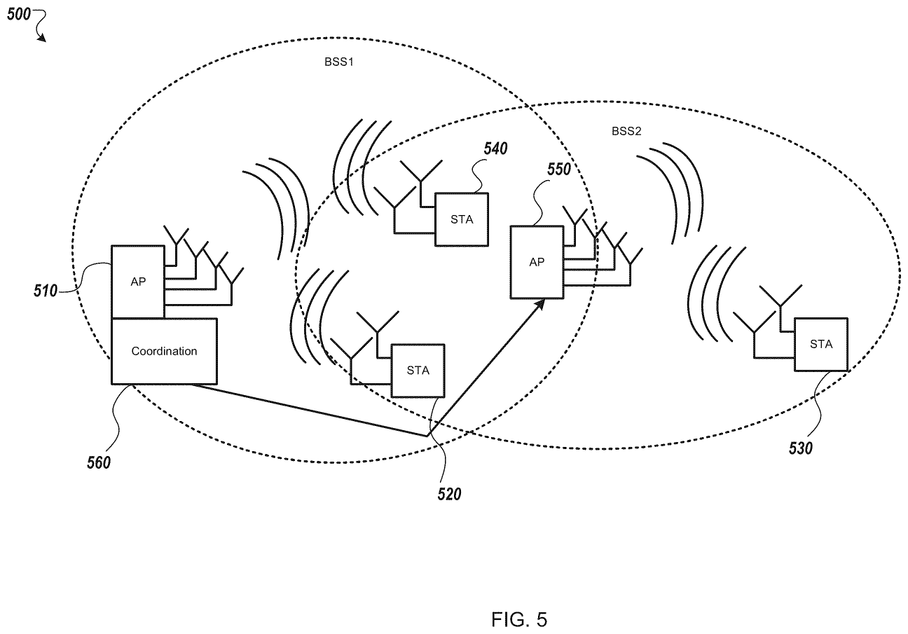

FIG. 6 illustrates an example of a packet sequence for joint sounding in an extended service set (ESS) and triggered coordinated spatial reuse (C-SR) transmission.

FIG. 7 illustrates a rate region for 2 users, comparing rate point of joint optimization (best sum rate), vs. best rate for the primary user minus a penalty (e.g., ΔNI=3 dB).

FIG. 8 illustrates an example communication system operable for spatial reuse.

FIG. 9 illustrates a process flow of an access point for spatial reuse.

FIG. 10 illustrates a process flow of a station used for spatial reuse.

FIG. 11 illustrates a process flow for coordination device used for spatial reuse.

FIG. 12 illustrates a diagrammatic representation of a machine in the example form of a computing device within which a set of instructions, for causing the machine to perform any one or more of the methods discussed herein, may be executed.

FIG. 13 illustrates an example a simulation setup in which each basic service set (BSS) spans over all 3 rooms, e.g., a station (STA) can connect to both access points (APs) from each room.

FIG. 14 illustrates simultaneous transmission without coordination, both APs transmit simultaneously with full power (there is no difference between primary and secondary).

FIG. 15 illustrates C-SR transmission in which acceptable transmit (TX) power for the secondary CSR transmission is selected such that interference and RX noise have equal strength. AP1 is the primary AP for 50% of the transmit time and AP2 is the primary AP for 50% of the transmit time.

FIG. 16 illustrates C-SR transmission in which acceptable TX power for the secondary CSR transmission is selected such that interference power at the STA can be 5 dB higher than RX noise. AP1 is the primary AP for 50% of the transmit time and AP2 is the primary AP for 50% of the transmit time.

FIG. 17 illustrates an examples of nulling transmission in which acceptable interference for secondary transmission is equal to the receiver noise. Nulling may be used to lower the interference to this level.

### DETAILED DESCRIPTION

In dense WLAN environments with multiple networks within reach of each other using the same frequency channel, interference between the networks may be a major source of performance degradation, causing increased latency and reduced data rates.

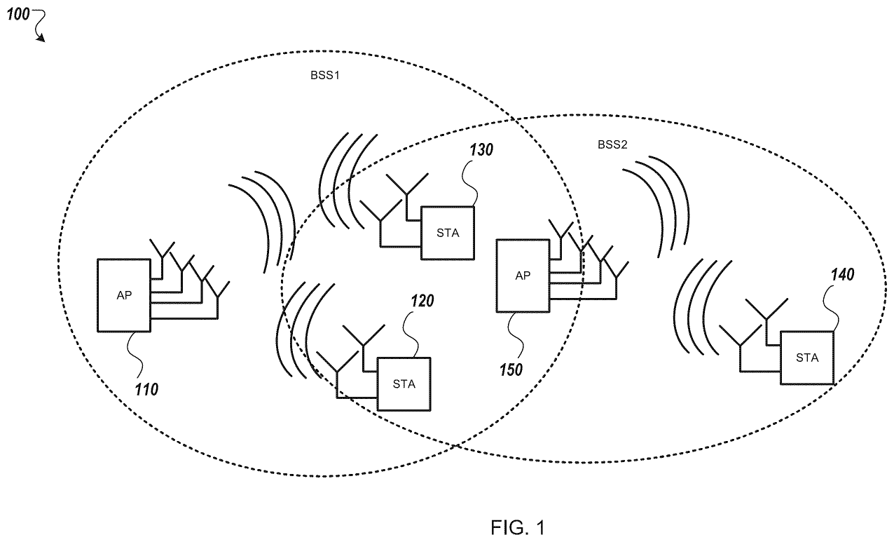

FIG. 1 shows two overlapping networks 100 of two WLANs, each consisting of an access point (AP) 110, 150 and one or more stations (STA) 120, 130, 140, each equipped with multiple antennas. In general, each AP or STA that may transmit data may perform the clear channel assessment (CCA) mechanism to avoid collisions of simultaneous transmissions.

The basic service set (BSS) may be independent of each other, or the BSS may be part of an extended service set (ESS) which allows the STAs to move from one BSS to the other BSS and provides additional coordination capabilities. The listen-before-talk protocol or a request to send (RTS)/clear to send (CTS) protocol may reduce collisions, but may also limit the efficient use of spectrum and transmit time.

Coordinated Spatial Re-Use (C-SR) is a method to allow simultaneous transmissions under certain conditions, which increases throughput and reduced latency.

Coordinated spatial re-use may be used to control the interference between simultaneous transmissions to avoid a packet loss. For spatial re-use, e.g., the simultaneous transmission at the same time on the same frequency band from two or more WLAN transmitters, interference may be controlled by one or more of: (i) adjustment of transmit power, (ii) increased robustness, e.g., by adjusting the modulation scheme and/or the forward error correction (FEC) overhead, or (iii) multiple input multiple output (MIMO) beamforming/precoding.

For each of these methods, knowledge about the interference from the transmitters, as it is experienced by the receivers, may be collected.

For independent overlapping BSS (OBSS), the assignment of stations to access points may be provided. In some examples, the primary transmission may not be aware of the spatial re-use (the second transmission at the same time) in which interference from the secondary transmission is to be minimal.

One consideration is the allocation of transmit power (e.g., for the secondary transmission). Determining the transmit power may be based on knowledge of the acceptable interference at the STA receiver, which may be provided by the STAs.

Transmit power allocation for APs performing the C-SR transmission may be determining by one or more of: (i) first AP may get the channel and send with full power, (ii) second AP may determine whether C-SR is possible and, if yes, may determine the correct TX power and/or precoding/beamforming matrix to reduce interference for the primary transmission below the acceptable level. These operations may be used for two independent networks.

Alternatively or in addition, when using the transmit precoding/beamforming matrix to reduce interference (e.g., spatial nulling), the goal is not to cancel interference between the APs completely, but to reduce it below an acceptable level.

In a coordinated network (e.g., an extended service set (ESS)), an additional optimization step may be performed, which is the AP-STA assignment. This assignment may be performed using one or more of: (i) the primary AP or a central coordination device initiates a joint channel estimation, (ii) with knowledge of the channel conditions, STAs are assigned to be served by one of the APs, (iii) transmit power and/or precoding/beamforming matrices for both AP transmissions is found such that overall maximum throughput is achieved, or (iv) the increased interference due to spatial re-use is estimated and taken into account to select modulation scheme and FEC overhead (mcs).

When spatial nulling is used, there may be a trade-off between the level of residual interference vs. the precoder conditioning. The precoder/beamforming matrix may allow some interference and achieve a trade-off between interference and signal levels.

In some examples, WLANs (Wi-Fi® 5 and before) may perform clear channel assessment (CCA) without spatial re-use.

Wi-Fi® 6 may allow C-SR but without channel feedback from the affected stations. Thus, interference from simultaneous transmission may not cause undesired packet losses.

Perfect spatial nulling for coordinated multi-AP transmission comes with two disadvantages. First, the sum of spatial streams of all simultaneously served STAs must be less or equal to the number of antennas of the AP with the least number of antennas, which limits the usability of spatial nulling. Second, the power penalty on the transmit precoder due to spatial nulling can be high, especially in cases where the actual interference path is weak and the additional interference without nulling would not be too high.

In this disclosure, measurement methods for signal and interference power are presented. Protocols for exchange of the measurement results are presented. Aspects for power allocation with spatial re-use are defined.

In one example, C-SR may be used with independent overlapping BSS (OBSS). In this case, each STA may listen to sounding packets (non-data packet NDP) of the associated AP and other APs in reach. For the associated AP, a regular sounding feedback may be sent back to the AP. For un-associated APs, a C-SR feedback packet may be provided, e.g., the actual interference and the required transmit power back-off for simultaneous transmission, may be reported.

In one example, the feedback to the un-associated AP includes the compressed channel feedback for the channel from the un-associated AP to the STA to perform spatial nulling). An AP that decides to perform a C-SR transmission at the time, when this STA is served, must keep the interference level for the corresponding STA below the requested level, e.g., by reducing the transmit power or by spatial nulling.

In another example, C-SR may be used in an ESS and the APs may coordinate their transmissions to a central coordination device that may perform coordination tasks for multiple APs. In this case, joint sounding may be performed.

One of the APs (the primary AP) or the coordination device, may trigger an NDP transmission from one or more secondary APs together with the primary AP with a given start time and sequence. The sequence length is such that the channel may be estimated between all APs transmit antennas and sounded STAs receive antennas. The STAs may sends the sounding feedback to their associated APs.

Based on the feedback, the sharing AP may perform one or more of: (i) select an optimized AP-STA association, (ii) trigger the transmission to the selected STAs from all the APs, (iii) in case of low interference, the transmit power is adjusted, (iv) in case of high interference, spatial nulling can be used, (v) as the interference/residual interference level is known from the sounding, the modulation and coding scheme and the number of spatial streams are selected accordingly.

In some examples, the AP uses implicit channel estimation to support the decisions. Hereby, the channel attenuation between STAs and the access point may be measured by receiving a packet from these STAs and measurement of the receive power and receive signal covariance. The receive signal covariance may be used to allow spatial nulling in cases where no channel estimation feedback was provided by the STA.

In some examples, the long training fields (LTFs) of data packets may be evaluated in addition to the NDPs to improve the channel measurement and track channel changes, e.g., for moving STAs.

The proposed method reduces channel blocking and thus, increases capacity, and achieves lower latency because the channel is not always blocked by transmissions of the neighboring BSS. The probability of packet loss during C-SR is minimized and the secondary AP has clear decision rules for the acceptable interference during simultaneous transmission.

Spatial nulling with the goal of completely cancelling the interference—the proposed method of reducing the interference to the acceptable level by spatial nulling, may provide a performance advantage for the disturber station which performs the nulling (because the matrix inversion is better conditioned). Furthermore, the partial null may be more robust against channel changes due to movement or other conditions.

In one example, C-SR is applied to independent overlapping BSS (OBSS). The AP-STA association may be provided by service set identifier (SSID). Hereby, a contention-based channel access may be performed and one of the APs wins the contention and thus, has primary access to the channel (primary AP).

For a beamforming or multiple user multiple input multiple output (MU-MIMO) transmission to the associated STAs, the primary AP may send a sounding packet to the associated STAs. The secondary AP may send sounding packet to the associated STAs. The sending of the sounding packets may occur on a periodic basis.

Whenever a STA receives an NDP from the associated AP, the STA may answer with a sounding feedback packet. Whenever a STA receives an NDP from an un-associated AP, the STA may answer with a C-SR feedback packet, which may be a smaller packet which may not contain the full MIMO feedback report.

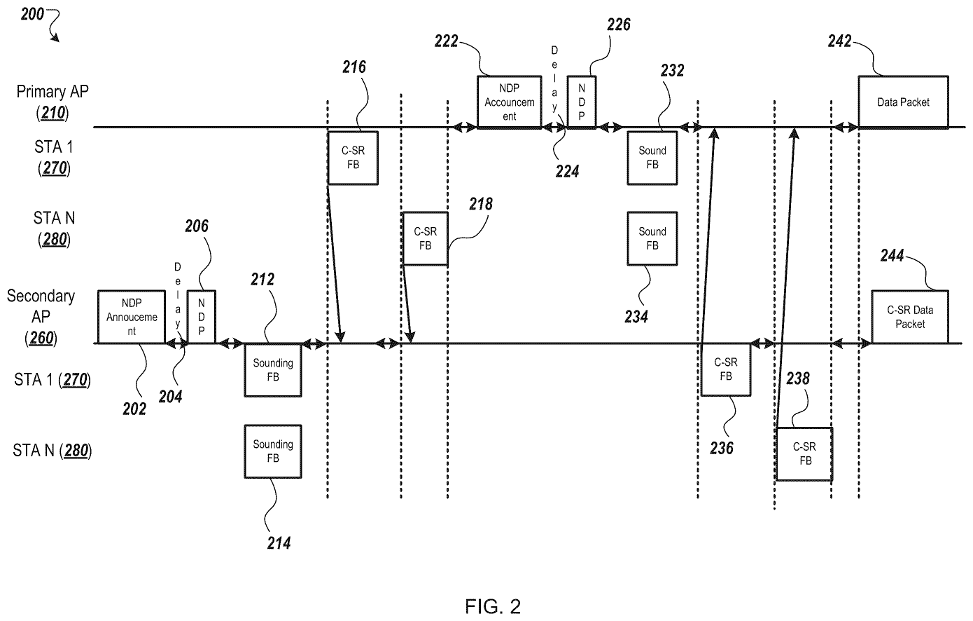

As illustrated in the timing diagram 200 in FIG. 2, a secondary AP 260 may provide a null data packet (NDP) announcement 202, followed by a delay 204, and the sending of the NDP 206. STA 1 270 and STA N 280 may send sounding feedback 212, 214 when the AP is associated. STA 1 270 and STA N 280 may send C-SR feedback 216, 218 when the AP is not associated.

The primary AP 210 may provide an NDP announcement 222, followed by a delay 224, and the sending of the NDP 226. STA 1 270 and STA N 280 may send sounding feedback 232, 234 to the primary AP 210. The STA 1 270 and STA N 280 may send C-SR feedback 236, 238 to the primary AP. The primary AP 210 may send a data packet 242. The secondary AP 260 may send a C-SR data packet 244.

WLAN transmission is an orthogonal frequency division multiplex (OFDM) transmission on K carriers k=1, . . . , K, using N_{tx,s} transmit antennas from AP s. Each STA m=1, . . . , M has N_{rx,m} receive antennas.

The transmission may consist of multiple spatial streams l=1, . . . , L, where each STA receives Lₘ spatial streams such that L=Σₘ₌₁^{M} Lₘ. The overall number of receive antennas at a MU MIMO transmission is Nᵣₓ=Σₘ₌₁^{M} N_{rx,m}.

For precoded or beamformed transmission, the MIMO transmitter (the AP) applies a precoder matrix Pₘ^{(k)}∈ [symbol] ^{N}^{_{tx,s}}^{×L}^{ₘ} to the input signal vector uₘ^{(k)}∈ [symbol] ^{L}^{ₘ}, which gives the transmit signal vector

$${x}_{m}^{( k )} = {P}_{m}^{( k )} {u}_{m}^{( k )} \qquad ( 1 )$$

with xₘ^{(k)}∈ [symbol] ^{N}^{_{tx,s}}. The signal is transmitted over the channel and the receive signal is

$${y}^{( k )} = {H}^{( k )} {x}_{m}^{( k )} . \qquad ( 2 )$$

Each STA receiver applies receive equalization with the receive equalizer Gₘ^{(k)}∈ [symbol] ^{L}^{ₘ}^{×N}^{_{rx,m}} to recover the transmitted signal ûₘ^{(k)} as given by

$${\hat{u}}_{m}^{( k )} = {G}_{m}^{( k )} {y}_{m}^{( k )} . \qquad ( 3 )$$

For MIMO channel estimation, as well as for receiver initialization on regular data packets, LTF symbols with an orthogonal sequence for MIMO channel measurement are transmitted in the preamble of the symbols.

The sequence has a length of T≥N_{tx,s} symbols. At time t=1, . . . , T, the transmit signal vector uₘ^{(k),t} is transmitted.

The signals form orthogonal sequences such that

$$\frac{1}{T} {\sum }_{t = 1}^{T} {u}_{m}^{( k ) , t} {u}_{m}^{( k ) , t , H} = I$$

is satisfied. With knowledge of the transmitted sequence, the receiver can estimate the channel according to

$${H}_{e st , m}^{( k )} = \frac{1}{T} {\sum }_{t = 1}^{T} {\hat{u}}_{m}^{( k ) , t} {u}_{m}^{( k ) , t , H} . \qquad ( 4 )$$

Hereby, the source of the received signal may be the serving AP or an interfering AP. With repetitions of the orthogonal sequence or by averaging over neighboring carriers, the receiver noise covariance C_{noise,s}^{(k)} can be estimated in addition.

$${\hat{n}}_{m}^{( k ) , t} = {\hat{u}}_{m}^{( k ) , t} - {H}_{e s t , m}^{( k )} {u}_{m}^{( k ) , t} , \qquad ( 5 )$$

$${C}_{n o i s e , m}^{( k )} = \frac{1}{T} {\sum }_{t = 1}^{T} {\hat{n}}_{m}^{( k ) , t} {\hat{n}}_{m}^{( k ) , t , H} . \qquad ( 6 )$$

For that, statistical independence between the desired signal and the interference may be provided. Noise covariance estimation can be used, e.g., to estimate interference of an interfering transmission during the reception of the LTF symbols from the desired data or NDP transmission.

Based on the measurements described, the STA may evaluate interference from APs in reach, which work on the same band.

In one example, the interference power from an interfering AP may be measured during the NDP transmitted by the interfering AP, as illustrated in Error! Reference source not found. The (precoded) TX signal vector from the interfering APs at time instance t is referred to as x_{d}^{(k),t}.

For carrier k, the receiving STAs experiences the interference covariance C_{d→s}^{(k)}

$${C}_{d \to s}^{( k )} = \frac{1}{T} {\sum }_{t = 1}^{T} {H}_{d \to s}^{( k )} {x}_{d}^{( k ) , t} {x}_{d}^{( k ) , t , H} {H}_{d \to s}^{( k ) , H} = \frac{1}{T} {\sum }_{t = 1}^{T} {y}_{d \to s}^{( k ) , t} {y}_{d \to s}^{( k ) , t , H} \qquad ( 7 )$$

And the interference at antenna n and carrier k is p_{d→s}_{ₙ}^{(k)}[C_{d→s}^{(k)}]ₙₙ.

The averaged interference from disturbing AP d to STA s is:

$${p}_{d \to s} = \frac{1}{{KN}_{rx}} {\sum }_{k = 1}^{K} {\sum }_{n = 1}^{{N}_{rx}} {p}_{d \to {s}_{n}}^{( k )} \qquad ( 8 )$$

The STA has an intrinsic noise level σ² such that the overall noise+interference level |n|²=p_{d→s}+σ². The STA will assume a certain max. noise increase, e.g., ΔNI=3 dB, which gives

$${p}_{d \to s , allowed} = ( Δ NI - 1 ) {σ}^{2} , \qquad ( 9 )$$

$$e . g . , {P}_{d \to s , allowed} = {σ}^{2} for Δ NI = 3 dB .$$

The corresponding power backoff ΔPBO for the AP (relative to the transmit power of the NDP) is

$$Δ {PBO}_{d \to s} = min ( \frac{( Δ NI - 1 ) {σ}^{2}}{{p}_{d \to s}} , 1 ) . \qquad ( 10 )$$

The value of ΔPBO_{d→s} is bounded to be less tan one.

This power back-off can be communicated to the interfering AP. For the interfering AP, to perform simultaneous transmission while STA s is served, the tx power is

$${p}_{csr , d} = {{{min}_{vicitim}}_{STAs v}}_{served} {p}_{tx , d} Δ {PBO}_{d \to v} \qquad ( 11 )$$

The regular transmit power is p_{tx,d}, e.g., the transmit power used for NDP transmission.

In another example, the interference may be measured during the reception of the LTFs transmitted by the serving AP. The noise covariance measurement C_{noise,m}^{(k)} may be available. It is not possible to assign it to a specific disturber d, in case that there is more than one interfering transmission.

The diagonal elements of the noise covariance matrix are the sum of noise and interference, e.g.,

$${[ {C}_{noise , m}^{( k )} ]}_{nn} = {\sum }_{distur bers d} {p}_{d \to s} + {σ}^{2} . \qquad ( 11 )$$

Accordingly, the power back-off for disturbing APs

$$Δ PBO = \frac{( Δ NI - 1 ) {σ}^{2}}{\frac{1}{K} {\sum }_{k = 1}^{K} {[ {C}_{noise , m}^{( k )} ]}_{nn} - {σ}^{2}} . \qquad ( 12 )$$

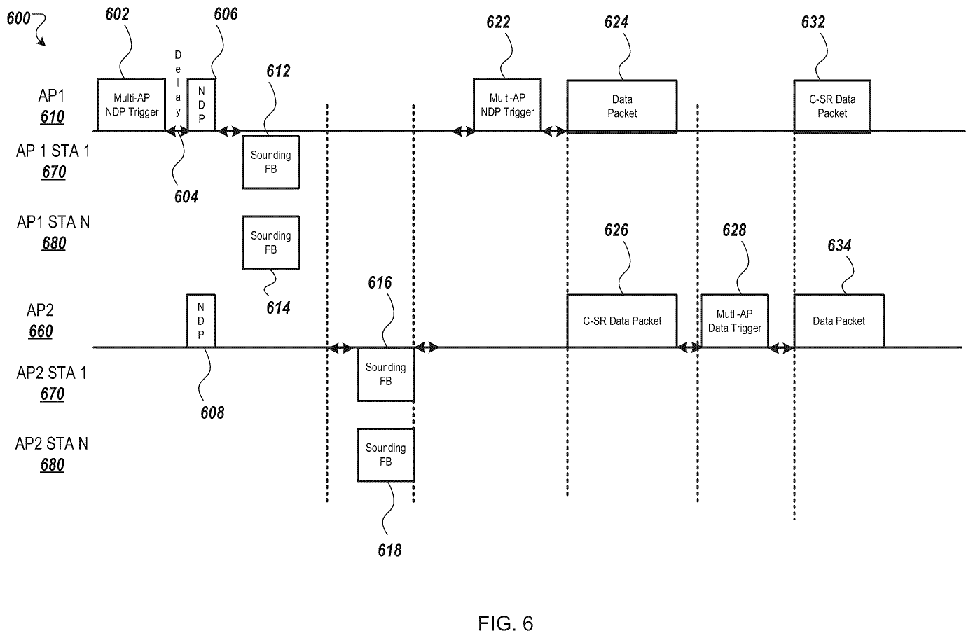

In another example, the disturbing AP and the serving AP may perform a joint sounding (see FIG. 6) with an orthogonal sequence of length T that allows a channel estimation of the direct channels and the interfering channels

$$\frac{1}{T} {\sum }_{t = 1}^{T} {[ \begin{matrix}{u}_{m}^{( k ) , t} \\ {u}_{d}^{( k ) , t}\end{matrix} ] [ \begin{matrix}{u}_{m}^{( k ) , t} \\ {u}_{d}^{( k ) , t}\end{matrix} ]}^{H} = I . \qquad ( 13 )$$

The estimated channel is now:

$${H}_{est}^{( k )} = [ \begin{matrix}{H}_{est , m}^{( k )} & {H}_{est , d \to m}^{( k )} \\ {H}_{est , m \to d}^{( k )} & {H}_{est , d}^{( k )}\end{matrix} ] \qquad ( 14 )$$

The interference covariance is

$${C}_{d \to m}^{( k )} = {H}_{est , d \to m}^{( k )} {C}_{x , d}^{( k )} {H}_{est , d \to m}^{( k ) , H}$$

With a transmit covariance C_{x,d}^{(k)} of the disturbing AP, e.g.,

$${C}_{x , d}^{( k )} = \frac{{p}_{tx , d}}{{N}_{tx , d}} I .$$

With knowledge of the interference covariance, the power back-off is computed in the same way as for the interference measurement from an isolated NDP transmission from the disturbing AP.

In one example, averaging over the carriers k=1, . . . , K is performed. In another example, averaging is performed over a group of carriers, e.g., a fixed number of N_{g} carriers or the carriers of a resource unit (RU). Accordingly, the power back-off is communicated to the disturbing AP as an average over all carriers, per carrier group or per RU.

Even though the additional interference from C-SR can be kept low, there is always an increase of the receiver noise+interference for the primary transmission receiver due to the secondary transmission. The noise+interference increase ΔNI is relevant to decide for the modulation and coding scheme and the transmission settings.

In one example, the AP defines the value of ΔNI and communicates to the STAs.

In another example, ΔNI is determined by the STA and conveyed to the AP to select the transmission settings. Depending on the method, which the AP uses to decide for the transmission settings (modulation and coding scheme and number of spatial streams), the communication is different.

In one example, the noise margin value, corresponding to ΔNI is communicated to the AP, using a dedicated message.

In another example, the AP decides for the transmission settings, based on the signal to noise ratio (SNR) feedback in the sounding feedback response. The STA, when sending the sounding feedback response, reduces the measured SNR by ΔNI and with that, the transmission settings selected by the AP will give sufficient margin for the interference from the secondary transmission.

In another example, the AP decides for the transmission settings, using a trial-and-error method. When the STA receives a packet while the secondary transmission takes place or the transmission settings give sufficient margin to work with interference, nothing may be performed. But when the STA receives a packet while there is no secondary transmission, and the transmission settings are such that the packet reception will fail in presence of interference, the STA may artificially increase the noise level by ΔNI or respond with a negative acknowledge to such packets. Then, the link adaptation of the AP may act accordingly and keep settings that are stable in presence of interference from a secondary transmission.

When receiving the sounding NDP from the serving AP, the compressed channel feedback to the serving AP consists of two sets of data, the compressed channel matrices, which are the normalized V matrices of a singular value decomposition U·S·V^{H}=Hₑₛₜ of the estimated channel matrix. In addition, the expected SNR, derived from the singular values S, is reported per antenna SNRₙ or per antenna and carrier group SNRₙ^{(k)}. The compressed V matrices are equivalent to the effective channel, e.g., the product of channel and receive equalizer H_{eff}=G·H with G=S⁻¹·U^{H}.

In general, the C-SR feedback packet contains an ID to allow the receiving AP (the disturber AP) to identify the STA.

In one example, the C-SR feedback packet contains the power backoff ΔPBO_{d→s} that is to be applied when the disturbing AP transmits simultaneously with a transmission serving the respective STA that sends the C-SR feedback. ΔPBO_{d→s} can be a single value, which is the average for all carriers. In another example multiple carrier or carrier group-dependent values, ΔPBO^{(k)} k=N_{g.}, 2N_{g.}, . . . , K are contained in the feedback report.

In addition, the interference power p_{d→s}^{(k)} can be communicated in the feedback packet. Either as a single averaged value p_{d→s} for all carriers or per carrier group or per RU.

To enable nulling of interference, the STA provides the effective disturber channel

$${H}_{eff , d \to m}^{( k )} = {G}_{m}^{( k )} \cdot {H}_{est , d \to m}^{( k )} .$$

As for the compressed V matrices of the regular sounding feedback, a scaled representation Ĥ_{eff,d→m}^{(k)}=diag(s^{(k)}) H_{est,d→m}^{(k)}. can be used, where the scale vector s^{(k)} is selected to reduce the quantization error of the feedback.

In another example, the C-SR feedback was measured by joint sounding (see FIG. 6). In this case, the STA has performed a measurement of H_{est,m}^{(k)} and H_{est,d→m}^{(k)}, while H_{est,d→m}^{(k)} is relevant for the disturbing AP and thus, to be communicated in the C-SR feedback report.

A compressed form of H_{est,d→m}^{(k)}, e.g., an amplitude/phase format or a normalized form of the U and V^{H} matrices of the SVD of H_{est,d→m}^{(k)} together with the singular values s and the maximum acceptable interference level ΔNIσ² are part of the C-SR feedback report.

With that, the interfering AP may decide to reduce transmit power and transmit simultaneously to a transmission serving STA m. In addition, the transmit precoding of the interfering AP can be selected to reduce interference (spatial nulling).

The secondary AP may start a C-SR transmission that overlaps with the primary transmission, when the following conditions are satisfied: (1) the preamble of the primary transmission was received, (2) from the STAs that are served by the primary transmission and (a) a C-SR feedback packet has been received, (b) or the STA is of reach of the secondary transmission (e.g., the NDP feedback that this STA has sent to the primary AP was not detectable), or (c) a spatial NULL can be created towards that STA to reduce interference below the threshold, (3) the channel quality achieved by the secondary transmission is high enough to ensure successful reception of the packet. The threshold depends on the modulation and coding settings. The transmit power for the C-SR transmission may defined by Eq. (11).

In one example, the channel quality of the secondary transmission evaluated by trial-end-error, e.g., a packet is transmitted with low modulation and coding settings and in case it is received successfully, the MCS can be increased in subsequent transmissions.

In another example, the interference level p_{s→d}^{(k)} from the primary AP is known from the C-SR feedback packet that has been transmitted by the served STA. Then, the expected signal to interference plus noise ratio (SINR) is given by

$${SINR}_{expect , d} = \frac{{p}_{tx , d} Δ {PBO}_{d \to v}}{\frac{{p}_{tx , d}}{{SNR}_{NDP , d}} + {p}_{s \to d}^{( k )}} \qquad ( 15 )$$

The AP can use it to decide whether it performs the C-SR transmission.

Even in case that the interference level is not acceptable for simultaneous transmission, transmission may occur, using nulling. Hereby, the transmit precoding for the secondary transmission is selected such that the interference at the victim STAs is reduced below the desired level. Disturber channel estimation feedback, e.g., the effective disturber channel H_{eff,d→m}^{(k)} is used to perform nulling.

The primary AP or the secondary AP without nulling calculate the (zero-forcing) precoder matrix according to

$${P}_{1}^{( k )} = {{H}_{eff}^{( k ) , H} ( {H}_{eff}^{( k )} {H}_{eff}^{( k ) , H} )}^{- 1} diag ( {s}^{( k )} ) \qquad ( 16 )$$

$$with$$

$${H}_{eff}^{( k )} = [ \begin{matrix}{H}_{eff , 1}^{( k )} \\ ⋮ \\ {H}_{eff , {M}_{1}}^{( k )}\end{matrix} ] . \qquad ( 17 )$$

The scaling factors s^{(k)} are selected to satisfy the power constraints. This is an example. Other methods, e.g., block diagonal or MMSE (minimum mean squared error) can be used.

For the secondary AP, which serves STAs d=1, . . . , D and creates a spatial null towards STA m, the effective channel is

$${H}_{eff}^{( k )} = [ \begin{matrix}{H}_{eff , 1}^{( k )} \\ ⋮ \\ {H}_{eff , {D}_{2}}^{( k )} \\ {H}_{eff , d \to m}^{( k )}\end{matrix} ] \qquad ( 18 )$$

Perfect nulling is achieved by

$${P}_{ext 2}^{( k )} = {{H}_{eff}^{( k ) , H} ( {H}_{eff}^{( k )} {H}_{eff}^{( k ) , H} )}^{- 1} , \qquad ( 19 )$$

a full matrix inversion and selection of the sub-matrix that serves the STAs d=1, . . . , D:

$${P}_{2}^{( k )} = {[ {P}_{ext 2}^{( k )} ]}_{{N}_{tx} \times {\sum }_{d} {L}_{d}} diag ( {s}^{( k )} ) . \qquad ( 20 )$$

Depending on the conditioning of the matrix, the scaling required to satisfy the power constrains will reduce the performance, compared to precoding without nulling.

In most cases, a perfect nulling as given by Eq. (20), may result in a high penalty to condition the precoding matrix. In practice, a perfect null is not required, but the interference may be dropped below the accepted level, which allows some SNR loss. Hereby, an interference scaling parameter λ is introduced, where λₘ=0 represents perfect nulling and Δₘ>>[H_{eff}^{(k)}H_{eff}^{(k),H}]ₘₘ is the full interference case.

To introduce the scaling, Eq. (19) is changed to

$${P}_{ext 2}^{( k )} = {{H}_{eff}^{( k ) , H} ( {H}_{eff}^{( k )} {H}_{eff}^{( k ) , H} + {Λ}^{( k )} )}^{- 1} , \qquad ( 21 )$$

With Λ^{(k)}=diag([0, . . . , 0, λ₁, . . . , λ_{M}]^{(k)}), while Eq. (20) remains as is.

Eq. (21) represents the partial nulling implementation for zero-forcing precoding. For MMSE or BD precoding, the interference control parameter λ is introduced in a similar way. In the presented example of C-SR in independent networks, the performance improvement through nulling is limited, because the primary AP transmits without awareness of the secondary APs transmissions, e.g., doesn't perform nulling to reduce interference into them.

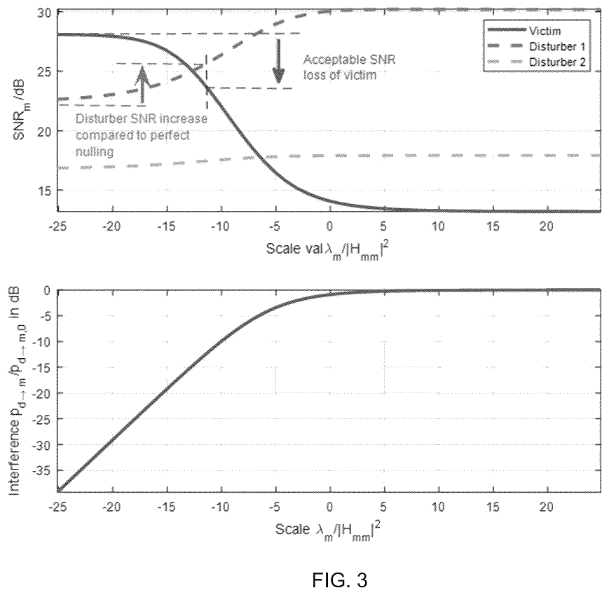

As shown in FIG. 3, an example of the control of the nulling interference relationship is provided. In this example, the disturber SNR may increase compared to perfect nulling, and the acceptable SNR may drop for the victim. The SNR for the victim may drop which may coincide with an increase in interference for the victim.

Unreasonably low acceptable interference levels in the C-SR feedback packet may be avoided. The STAs may get some benefit for allowing interference. For example, the AP may define some acceptable interference adder for the STA (this makes sense because the AP may decide on the modulation and coding scheme (MCS) and may take some margin for interference into account).

The AP, when it allows more spatial re-use, gets higher priority for the channel access in return. This is acceptable for the AP to get the channel more often because it doesn't block the channel completely.

In some examples, multiple access points may form an extended service set (ESS), which may allow more advanced coordination between the access points. Within the managed network, the coordination device assigns stations to access points and allocates resources for simultaneous transmission.

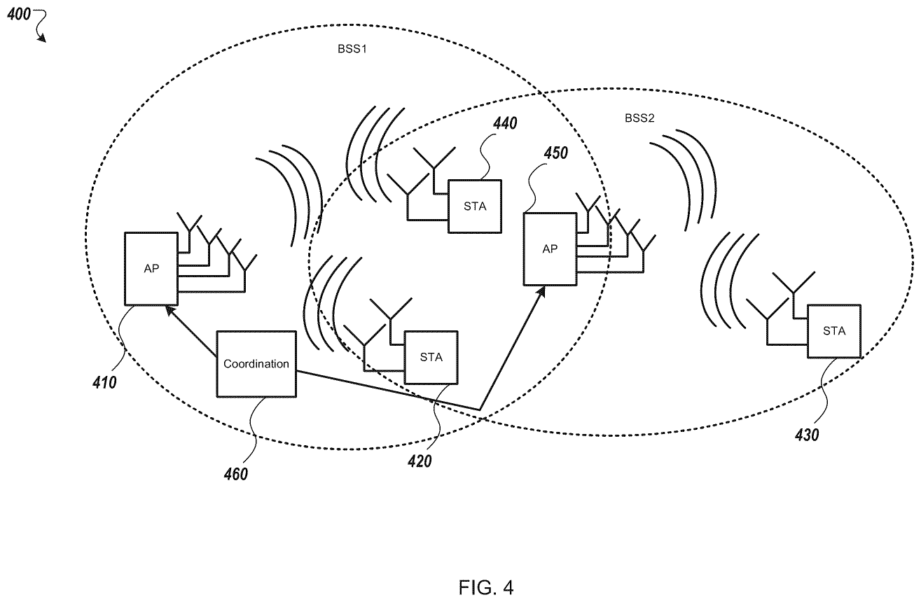

In one example, as shown in the two overlapping networks 400 in FIG. 4, the coordination device 460 may be a separate device in the network, which may be connected to all the access points with a wired or wireless back-haul connection. In this example, the AP 410 may be a part of BSS 1, the AP 450 may be a part of BSS2. The STAs 420, 430, 440 may be a part of the network. The coordination device 460 may coordinate between AP 410 and AP 450.

In another example, shown in the two overlapping networks 500 in Error! Reference source not found., the coordination is part of one of the access points. The AP which performs coordination among the ESS may change from packet to packet. The coordination device 460 may be integrated with the AP 410. In this example, the AP 510 may be a part of BSS 1, the AP 550 may be a part of BSS2. The STAs 520, 530, 540 may be a part of the network. The coordination device 560 may coordinate between AP 510 and AP 550.

In one example, the precoder coefficient calculation may be done in the coordination device and communicated to the other APs for the joint transmission. In one example, the joint power allocation may be done in the coordination device and each AP may calculate the precoding or beamforming coefficients locally.

For coordinated transmission in the managed network, a joint sounding procedure can be used, as illustrated in the timing diagram 600 in FIG. 6. It is initiated by one of the APs or by the coordination device.

AP1 610 may transmit a multi-AP NDP trigger 602, followed by a delay 604, and a null data packet 606. AP2 660 may transmit a null data packet 608. STA 1 670 and STA 2 680 may transmit sounding feedback 612, 614 to AP1 610. STA 1 670 and STA 2 680 may transmit sounding feedback 616, 618 to AP2 660. AP1 610 may transmit a multi-AP trigger 622 followed by a data packet 624. AP2 660 may transmit a C-SR data packet 626, followed by a multi-AP data trigger 628 and a data packet 634. AP1 610 may transmit a C-SR data packet 632.

In the managed multi-AP network, additional degrees of freedom can be used for optimization, e.g., the STAs can be moved to another AP for overall performance improvement and the primary transmission can be performed with higher interference to increase the overall throughput.

Fairness is not ensured by fixed rules from the standard, but by a central management entity that can be part of one of the APs or at another location in the network.

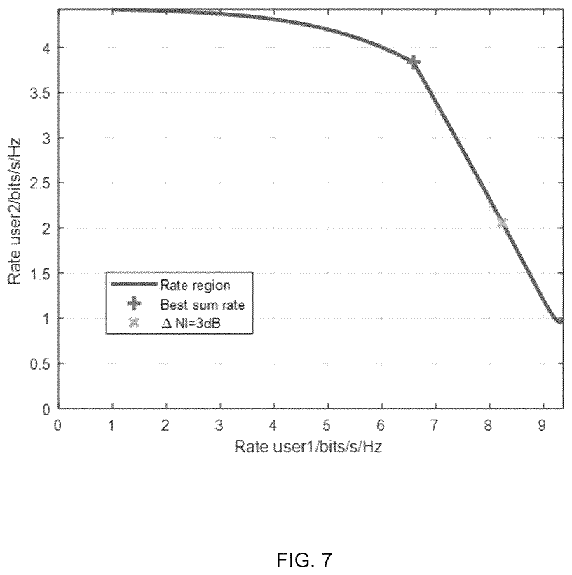

In the managed network, we can make the primary AP aware of the secondary APs transmission and interference. The primary AP can reduce its MCS accordingly. And the secondary AP can transmit with higher power to come to the joint optimum. In most cases, the sum rate of primary and secondary users for the joint optimum is higher than the rates achieved, when the primary user is protected. An example is shown in FIG. 7. While it is possible to do a search for the optimum power allocation, in most cases with a rate region as shown in FIG. 7, where C-SR brings a gain, the joint optimum rate may be achieved when both APs transmit with full power and a full search is not necessary.

In one example, the power allocation optimization is performed by the AP that triggers the C-SR transmission. The power levels are communicated in the Multi-AP data trigger. In another example, there may be a separate entity in the network, which may perform the resource allocation for multiple connected APs.

The individual transmitting APs may decide whether they in fact use the transmit opportunity and which MCS they use, using knowledge of the interference level, as provided from the optimization.

In a coordinated network, STAs can be served by multiple APs in reach. In most cases, the closest AP, e.g., the minimum AP-STA attenuation may give the best assignment. But especially in cases where the attenuation difference between the APs is small, the free capacity of an AP may be taken into account.

Rate optimized AP-STA association can be performed as an iterative process, where each STA is re-assigned to the AP that gives the highest overall data rate. For a single STA, it is possible to test all possible options, e.g., all APs in reach and evaluate the overall rate.

While in the case of independent networks, the secondary APs perform nulling, while the primary AP causes full interference to them, the managed network may use mutual nulling by default. The primary AP and the secondary AP may perform nulling whenever the overall rate is increased.

For the primary AP to perform nulling, resources are required, e.g., the number of spatial nulls plus transmitted spatial streams may not exceed the number of TX antennas of the AP. Thus, nulling may only be applied when the resources are free or when the gain for the secondary AP is higher than the loss for the primary AP when re-allocating the resources.

Latency reduction may be another objective, e.g., with C-SR and nulling, more STAs can be served simultaneously such that the overall latency is lower than for time multiplexing.

In one example, the precoder coefficients for nulling are calculated jointly, e.g., by the coordination device or by one of the APs. Hereby, a joint optimization of the individual precoders of the APs is possible, e.g., by an iterative optimization.

The individual precoder matrices of multiple APs, e.g., P₁^{(k)} and P₂^{(k)} form a joint precoder matrix

$${P}^{( k )} = [ \begin{matrix}{P}_{1}^{( k )} & 0 \\ 0 & {P}_{2}^{( k )}\end{matrix} ]$$

where the coefficients which are not associated with any of the APs are zero.

Similarly, a joint equalizer matrix

$${G}^{( k )} = [ \begin{matrix}{G}_{1}^{( k )} & & 0 \\ & ⋱ & \\ 0 & & {G}_{M}^{( k )}\end{matrix} ]$$

is formed from the individual STAs equalizers matrices.

The equalizer for STA m is given by:

$${G}_{m}^{( k )} = {{H}_{eff , m}^{( k ) , H} ( {H}_{eff , m}^{( k )} {H}_{eff , m}^{( k ) , H} + {C}_{nxm}^{( k )} )}^{- 1}$$

With H_{eff,m}^{(k)}=Hₘ^{(k)}Pₘ^{(k)}, where Pₘ^{(k)} contains the columns of the Precoder matrix associated with STA m, e.g., P^{(k)}=[P₁^{(k)}, . . . , P_{M}^{(k)}] and Hₘ^{(k)} contains the rows associated with the receive antennas of STA m, e.g.,

$${H}^{( k )} = [ \begin{matrix}{H}_{1}^{( k )} \\ ⋮ \\ {H}_{m}^{( k )}\end{matrix} ] .$$

The noise+crosstalk covariance matrix C_{n×m}^{(k)} is given by

$${C}_{nxm}^{( k )} = {σ}^{2} I + {\sum }_{d \neq m} {H}_{m}^{( k )} {P}_{d}^{( k )} {P}_{d}^{( k ) , H} {H}_{m}^{( k ) H}$$

The precoder is computed in the dual uplink, on the dual uplink channel

$${H}_{dual}^{( k )} = {( {G}^{( k )} {σ}^{- 1} {H}^{( k )} )}^{H}$$

The dual uplink equalizer G_{dual}^{(k)}=P^{(k),H} for AP s is given by

$${G}_{dual , s}^{( k )} = \sqrt{{X}_{dual , s}^{( k )}} {{H}_{dual , s}^{( k ) ,} ( {H}_{dual , s}^{( k )} {H}_{dual , s}^{( k ) , H} + {C}_{nxs}^{( k )} )}^{- 1}$$

$$with$$

$${C}_{nxs}^{( k )} = {μ}_{sum , s} I + {\sum }_{d \neq m} {H}_{dual , d}^{( k )} {X}_{dual , d}^{( k )} {H}_{dual , d}^{( k ) H} .$$

X_{dual}^{(k)}=diag([x_{daul,1}^{(k)}, . . . , x_{daul,L}^{(k)}]) is the uplink power optimization, with is transformed from uplink to downlink, using the equation SNR_{dual,l}^{(k)}=SNRₗ^{(k)}. μ_{sum,s} is the Lagrangian variable of the per-AP sum-power constraint. It is updated according to

$${μ}_{sum , s}^{t + 1} = max ( {μ}_{sum , s}^{t} + α ( {p}_{sum , s} - {p}_{limit , s} ) , 0 ) .$$

With multiple iterations of precoder and equalizer updates, the optimal nulling precoders for APs may be found.

The STA receiver for C-SR may be capable to mitigate interference. As interference from other APs is spatially correlated noise, receiver side interference mitigation may be very effective, especially when the number of RX antennas of the STA is higher than the number of receiver spatial streams. With each additional receive antenna, one disturber can be canceled.

For that, the receive covariance is estimated and taken into account for equalizer calculation, e.g., by calculating the equalizer according to

$${G}_{m}^{( k )} = {{H}_{eff , m}^{( k ) , H} ( {H}_{eff , m}^{( k )} {H}_{eff , m}^{( k ) , H} + {C}_{nxm}^{( k )} )}^{- 1} .$$

The C-SR is symmetric, in general. For uplink transmissions, the AP is the receiver and thus, gives the information about the acceptable interference levels.

The main difference is that uplink transmission may be performed without sounding packets transmitted from the STAs. Therefore, the APs may rely on implicit measurements to identify interference.

APs may send C-SR packets to STAs or to other APs to allow them for simultaneous transmission, while they receive an uplink transmission.

In another example, symbol alignment is used for precoding to be effective. Start time alignment may be used because otherwise the (non-precoded) preamble (before the extremely high throughput long training field (EHT-LTF) may cause crosstalk from the secondary APs into the primary AP transmission. To avoid interference, C-SN transmissions may start simultaneously, triggered by the primary AP (for both half-coordinated and fully coordinated scenarios).

In another example, to simplify the C-SN operation, the trigger frame may include information, e.g., the STAs served and the acceptable interference per STA (e.g., when a higher level of interference than indicated by the STA feedback is acceptable, due to the selected MCS).

In another example, the STA allows a certain increase of noise+interference (e.g., 3 dB) for C-SN. Feedback contents for AP d: Power backoff ΔPBO_{d→v} to keep interference from AP d to STA v below the desired limit, together with null space feedback. When AP d transmits while STA v receives the transmit power is reduced such that p_{tx C-SR,d}≤P_{tx sounding,d}ΔPBO_{d→v}. In case the required reduction is high, spatial nulling can be used to reduce interference while keeping a higher transmit power

$${p}_{tx C - SR , d} \leq min ( {p}_{tx sounding , d} \frac{Δ {PBO}_{d \to v}}{λ} , {p}_{max} ) ,$$

where λ controls the depth of the null.

In another example, null space feedback may be determined.

Sounding feedback may be determined by: Channel estimate H_{est,s→v}^{(k)}; Singular Value Decomposition H_{est,s→v}^{(k)}=U_{s→v}^{(k)}S_{s→v}^{(k)}V_{s→v}^{(k),H}. The feedback V_{s→v}^{(k)}, which corresponds to the equalized channel Gᵥ^{(k)}H_{s→v}^{(k)}, using Gᵥ^{(k)}=S_{s→v}^{(k),-1} U_{s→v}^{(k),H}.

C-SN feedback may be determined by: Channel estimate H_{est,d→v}^{(k)} from un-associated AP NDP; Singular Value Decomposition H_{est,d→v}^{(k)}=U_{d→v}^{(k)}S_{d→v}^{(k)}V_{d→v}^{(k),H}; and the C-SR corresponds to the disturber channel at the equalizer output Gᵥ^{(k)}H_{d→v}^{(k)}. The feedback is H_{sn,d→v}^{(k)}=S_{s→v}^{(k),-1} U_{s→v}^{(k),H}H_{est,d→v}^{(k)}

In another example, multi-AP sounding can be done jointly to increase efficiency. Different APs act like a single AP and send the LTFs jointly (each AP uses a different spatial mapping on the LTFs). For joint precoder optimization, the sounding feedback is collected at the central coordination (e.g., AP1) to calculate precoders. The precoders may be distributed to other APs with a precoder message.

In another example, C-SN optimal partial nulling may be used. C-SR with only power back-off (no nulling) and C-SN with perfect nulling are extreme cases. Interference can be reduced by reducing transmit power or using spatial nulling or a combination of both. A perfect null (zero-forcing) often leads to an ill-conditioned precoder matrix. To avoid that, partial nulling with the nulling depth λ can be used. Perfect nulling can be worse than no nulling.

In another example, overhead may be determined. The overhead may include various assumptions such as: Baseline is MU-MIMO time division multiple access (TDMA); transmit opportunity (TXOP) duration: 6 ms; desired sounding interval around 10 ms (or 2 TXOPs); all management frames sent with MCS 0, full bandwidth; and C-SN feedback is 2 byte per carrier group.

In this case, the approximate overhead may be: (1) MU-MIMO Sounding (2 OBSS): Sounding overhead is approx. 7% of airtime; (2) MU-MIMO Sounding+C-SN feedback: Overhead increase from 7% to 10% (for C-SN feedback); (3) Joint Sounding: Reduced overhead from 7% to 6%.

In another example, a partial null may be compared to a perfect null. For sounding feedback, for data transmission, the effective channel may be characterized by the V matrix feedback V_{s→v}^{(k),H}. For C-SN feedback, for spatial nulling, there is the nulling feedback H_{sn,s→v}^{(k)}. For a perfect null,

$${H}_{eff}^{( k )} = [ \begin{matrix}{V}_{s \to v}^{( k ) , H} \\ {H}_{sn , s \to v}^{( k )}\end{matrix} ] and [ {P}_{s}^{( k )} {P}_{sx}^{( k )} ] = {{H}_{eff}^{( k ) , H} ( {H}_{eff}^{( k )} {H}_{eff}^{( k ) , H} )}^{- 1} .$$

For a partial null,

$${H}_{eff}^{( k )} = [ \begin{matrix}{V}_{s \to v}^{( k ) , H} \\ {H}_{sn , s \to v}^{( k )}\end{matrix} ] and [ {P}_{s}^{( k )} {P}_{sx}^{( k )} ] = {{H}_{eff}^{( k ) , H} ( {H}_{eff}^{( k )} {H}_{eff}^{( k ) , H} + {Λ}^{( k )} )}^{- 1} .$$

With λₗₗ=0 for associated STAs λₗₗ=(0, . . . , 1). [H_{eff}^{(k)}H_{eff}^{(k),H}]ₗₗ in which Λ^{(k)} is a diagonal matrix with diagonal elements λₗₗ.

In another example, nulling accuracy may depend on various contributing factors. Zero forcing (ZF) Nulling may not be perfect in practice because of: (i) channel estimation accuracy (feedback format, grouping and interpolation), (ii) channel aging, and (iii) clock differences between APs.

In another example, spatial nulling and symbol alignment can be performed. For OFDM symbol boundaries, spatial nulling is not perfect. The interference at the symbol boundaries depends on the channel characteristics (e.g., a flat channel doesn't cause interference at the symbol boundaries). Interference depends on the transmit signal characteristics, e.g., tx windowing. If OFDM symbol boundaries are aligned, this interference doesn't affect the receiver.

In another example, alignment may include various requirements. For timing and clock synchronization, the synchronization requirements are much lower than e.g., for joint transmission, where the acceptable drift of the sample timing is only a fraction of a sample. Depending on the channel conditions a shift of a few samples is acceptable. A clock accuracy of +−0.07 ppm is sufficient to stay within this range.

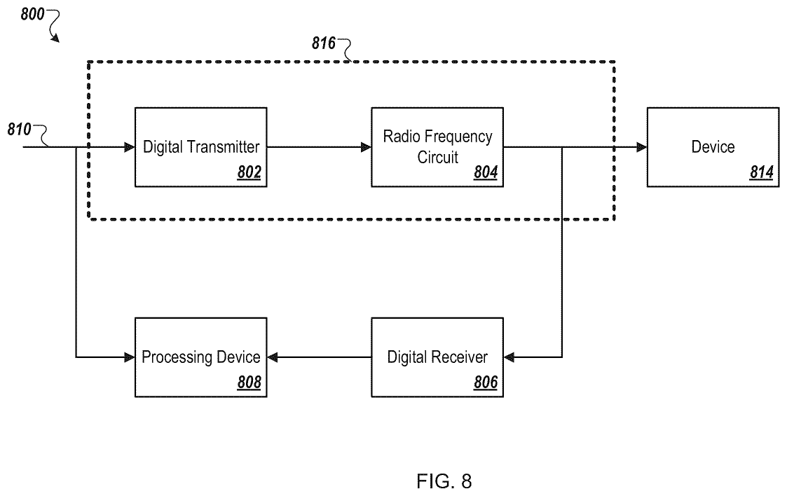

FIG. 8 illustrates a block diagram of an example communication system 800 configured for spatial reuse, in accordance with at least one example described in the present disclosure. The communication system 800 may include a digital transmitter 802, a radio frequency circuit 804, a device 814, a digital receiver 806, and a processing device 808. The digital transmitter 802 and the processing device may be configured to receive a baseband signal via connection 810. A transceiver 816 may comprise the digital transmitter 802 and the radio frequency circuit 804.

In some examples, the communication system 800 may include a system of devices that may be configured to communicate with one another via a wired or wireline connection. For example, a wired connection in the communication system 800 may include one or more Ethernet cables, one or more fiber-optic cables, and/or other similar wired communication mediums. Alternatively, or additionally, the communication system 800 may include a system of devices that may be configured to communicate via one or more wireless connections. For example, the communication system 800 may include one or more devices configured to transmit and/or receive radio waves, microwaves, ultrasonic waves, optical waves, electromagnetic induction, and/or similar wireless communications. Alternatively, or additionally, the communication system 800 may include combinations of wireless and/or wired connections. In these and other examples, the communication system 800 may include one or more devices that may be configured to obtain a baseband signal, perform one or more operations to the baseband signal to generate a modified baseband signal, and transmit the modified baseband signal, such as to one or more loads.

In some examples, the communication system 800 may include one or more communication channels that may communicatively couple systems and/or devices included in the communication system 800. For example, the transceiver 816 may be communicatively coupled to the device 814.

In some examples, the transceiver 816 may be configured to obtain a baseband signal. For example, as described herein, the transceiver 816 may be configured to generate a baseband signal and/or receive a baseband signal from another device. In some examples, the transceiver 816 may be configured to transmit the baseband signal. For example, upon obtaining the baseband signal, the transceiver 816 may be configured to transmit the baseband signal to a separate device, such as the device 814. Alternatively, or additionally, the transceiver 816 may be configured to modify, condition, and/or transform the baseband signal in advance of transmitting the baseband signal. For example, the transceiver 816 may include a quadrature up-converter and/or a digital to analog converter (DAC) that may be configured to modify the baseband signal. Alternatively, or additionally, the transceiver 816 may include a direct radio frequency (RF) sampling converter that may be configured to modify the baseband signal.

In some examples, the digital transmitter 802 may be configured to obtain a baseband signal via connection 810. In some examples, the digital transmitter 802 may be configured to up-convert the baseband signal. For example, the digital transmitter 802 may include a quadrature up-converter to apply to the baseband signal. In some examples, the digital transmitter 802 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 802.

In some examples, the transceiver 816 may include one or more subcomponents that may be used in preparing the baseband signal and/or transmitting the baseband signal. For example, the transceiver 816 may include an RF front end (e.g., in a wireless environment) which may include a power amplifier (PA), a digital transmitter (e.g., 802), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 804) of the transceiver 816 may be synchronized with the resource controller via the S-plane device, which may contribute to high-accuracy timing with respect to a reference clock.

In some examples, the transceiver 816 may be configured to obtain the baseband signal for transmission. For example, the transceiver 816 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 816 may be configured to generate a baseband signal for transmission. In these and other examples, the transceiver 816 may be configured to transmit the baseband signal to another device, such as the device 814.

In some examples, the device 814 may be configured to receive a transmission from the transceiver 816. For example, the transceiver 816 may be configured to transmit a baseband signal to the device 814.

In some examples, the radio frequency circuit 804 may be configured to transmit the digital signal received from the digital transmitter 802. In some examples, the radio frequency circuit 804 may be configured to transmit the digital signal to the device 814 and/or the digital receiver 806. In some examples, the digital receiver 806 may be configured to receive a digital signal from the RF circuit and/or send a digital signal to the processing device 808.

In some examples, the processing device 808 may be a standalone device or system, as illustrated. Alternatively, or additionally, the processing device 808 may be a component of another device and/or system. For example, in some examples, the processing device 808 may be included in the transceiver 816. In instances in which the processing device 808 is a standalone device or system, the processing device 808 may be configured to communicate with additional devices and/or systems remote from the processing device 808, such as the transceiver 816 and/or the device 814. For example, the processing device 808 may be configured to send and/or receive transmissions from the transceiver 816 and/or the device 814. In some examples, the processing device 808 may be combined with other elements of the communication system 800.

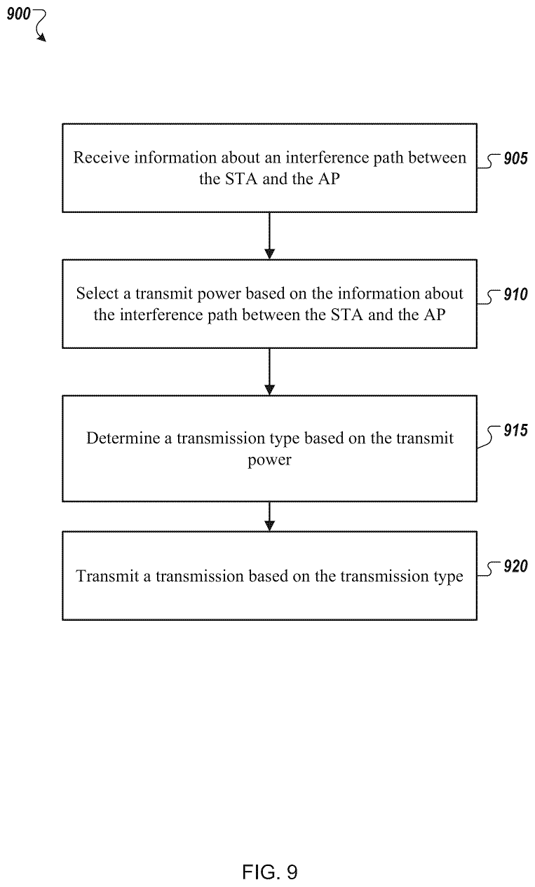

FIG. 9 illustrates a process flow of an example method 900 of spatial reuse, in accordance with at least one example described in the present disclosure. The method 900 may be arranged in accordance with at least one example described in the present disclosure.

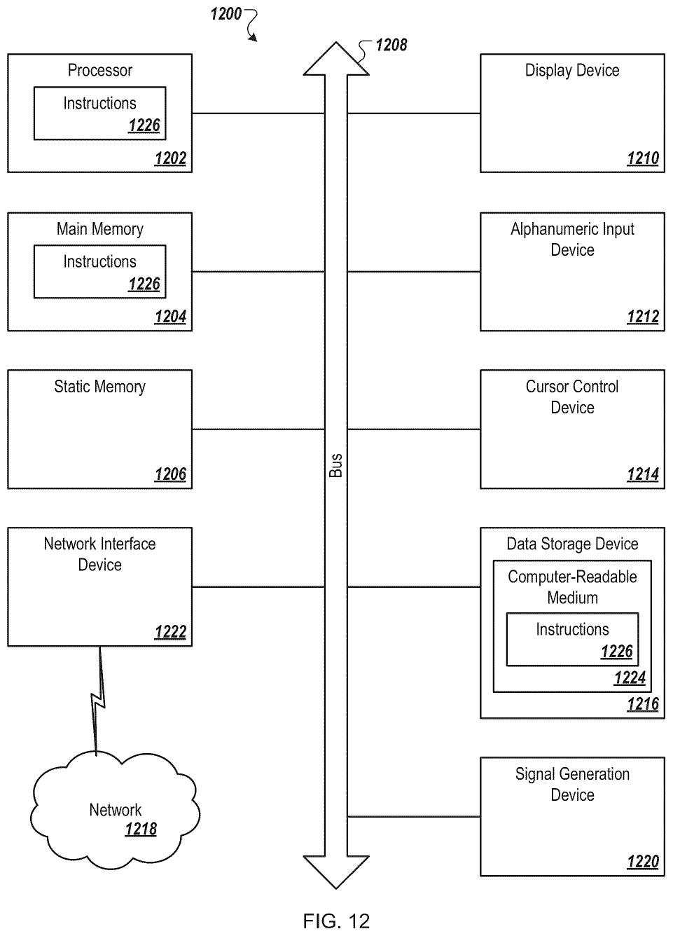

The method 900 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 800 of FIG. 8, or another device, combination of devices, or systems.

The method 900 may begin at block 905 where the processing logic may receive information about an interference path between the STA and the AP.

At block 910, the processing logic may select a transmit power based on the information about the interference path between the STA and the AP.

At block 915, the processing logic may determine a transmission type based on the transmit power.

At block 920, the processing logic may transmit a transmission based on the transmission type.

The information about the interference path between the STA and the AP may include one or more of a required transit power back-off for simultaneous transmission or a maximum acceptable transmit power of the AP.

The information about the interference path between the STA and the AP may include information used for spatial nulling.

The method may further include: receive, at the AP from an additional station (STA), additional information about an additional interference path between the additional STA and the AP; select, at the AP, the transmit power to be a minimum transmit power based on: the information about the interference path between the STA and the AP, and the additional information about the interference path between the additional STA and the AP.

The method may further include: compute the minimum transmit power based on a preamble of the transmission received from one or more of the STA or the additional STA; or compute the minimum transmit power based on the minimum transmit power for the STA and the additional STA.

The method may further include compute, at the AP, an expected signal quality for spatial re-use transmission, in which the transceiver may transmit the spatial re-use transmission when the expected signal quality for the signal re-use transmission is greater than a threshold.

The method may further include determine, at the AP, the transmission type as a spatial nulling transmission when a required transit power back-off for the STA is greater than a threshold.

The method may further include compute, at the AP, a noise and interference threshold; and send, from the AP to the STA, the noise and interference threshold.

The method may further include select, at the AP, one or more of: a modulation and coding scheme, or a number of spatial streams.

Modifications, additions, or omissions may be made to the method 900 without departing from the scope of the present disclosure. For example, in some examples, the method 900 may include any number of other components that may not be explicitly illustrated or described.

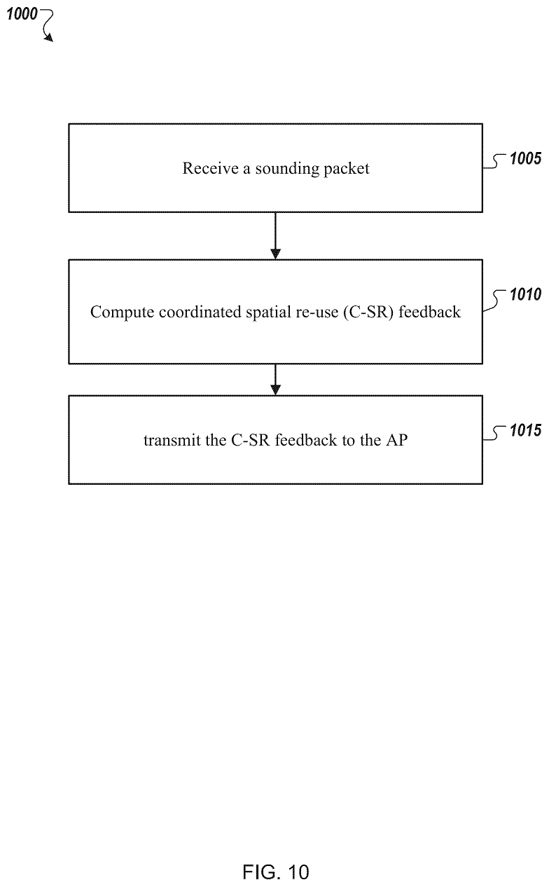

FIG. 10 illustrates a process flow of an example method 1000 that may be used for spatial reuse, in accordance with at least one example described in the present disclosure. The method 1000 may be arranged in accordance with at least one example described in the present disclosure.

The method 1000 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 800 of FIG. 8, or another device, combination of devices, or systems.

The method 1000 may begin at block 1005 where the processing logic may receive a sounding packet.

At block 1010, the processing logic may compute coordinated spatial re-use (C-SR) feedback.

At block 1015, the processing logic may transmit the C-SR feedback to the AP.

The C-SR feedback may be one or more of: a required power back-off for the STA, an effective channel estimate from the AP to the STA, or a signal-to-interference noise level.

The method may further include receive, at the STA from the AP, an acceptable interference and noise level; and compute, at the STA, a required power back-off based on the acceptable interference and noise level.

The method may further include compute, at the STA, an acceptable interference and noise level, in which the transceiver may transmit the acceptable interference and noise level to the AP.

The method may further include emulate, at the STA, an increased noise and interference level when a secondary transmission is not active.

Modifications, additions, or omissions may be made to the method 1000 without departing from the scope of the present disclosure. For example, in some examples, the method 1000 may include any number of other components that may not be explicitly illustrated or described.

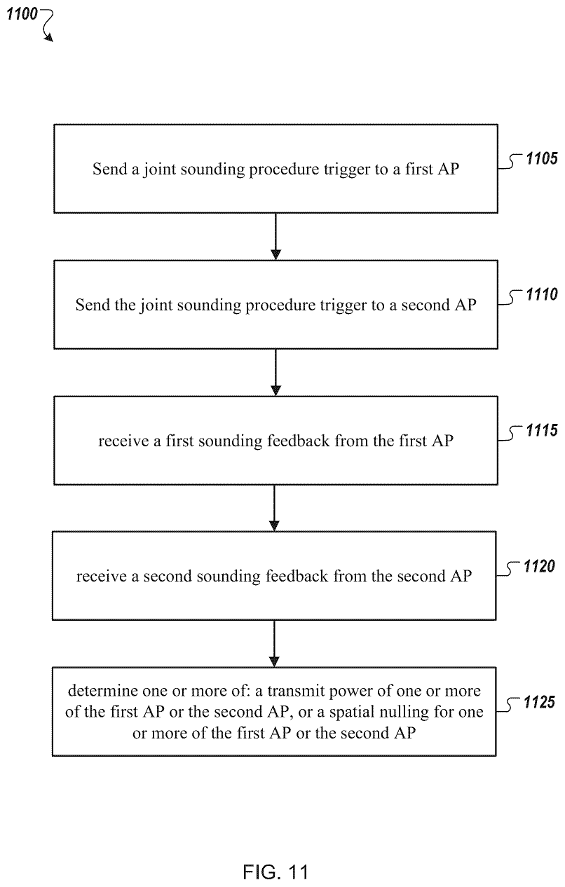

FIG. 11 illustrates a process flow of an example method 1100 that may be used for spatial reuse, in accordance with at least one example described in the present disclosure. The method 1100 may be arranged in accordance with at least one example described in the present disclosure.

The method 1100 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 800 of FIG. 8, or another device, combination of devices, or systems.

The method 1100 may begin at block 1105 where the processing logic may send a joint sounding procedure trigger to a first AP.

At block 1110, the processing logic may send the joint sounding procedure trigger to a second AP.

At block 1115, the processing logic may receive a first sounding feedback from the first AP.

At block 1120, the processing logic may receive a second sounding feedback from the second AP.

At block 1125, the processing logic may determine one or more of: a transmit power of one or more of the first AP or the second AP, or a spatial nulling for one or more of the first AP or the second AP.

The coordination device may be integrated with the first AP or the second AP. The coordination device may be separate from the first AP and the second AP.

The method may further include determine one or more stations (STAs) to be served simultaneously; associate the one or more STAs to the first AP or the second AP; or compute a transmit power for one or more of the first AP or the second AP.

The method may further include compute, at the coordination device, one or more beamforming coefficients for one or more of the first AP or the second AP.

The method may further include compute, at the coordination device, spatial nulling for one or more of the first AP or the second AP using the one or more beamforming coefficients.

Modifications, additions, or omissions may be made to the method 1100 without departing from the scope of the present disclosure. For example, in some examples, the method 1100 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 12 illustrates a diagrammatic representation of a machine in the example form of a computing device 1200 within which a set of instructions, for causing the machine to perform any one or more of the methods discussed herein, may be executed. The computing device 1200 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a LAN, an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1200 includes a processing device (e.g., a processor) 1202, a main memory 1204 (e.g., read-only memory (ROM), flash memory, dynamic random access memory (DRAM) such as synchronous DRAM (SDRAM)), a static memory 1206 (e.g., flash memory, static random access memory (SRAM)) and a data storage device 1216, which communicate with each other via a bus 1208.

Processing device 1202 represents one or more general-purpose processing devices such as a microprocessor, central processing unit, or the like. More particularly, the processing device 1202 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1202 may also include one or more special-purpose processing devices such as an application specific integrated circuit (ASIC), a field programmable gate array (FPGA), a digital signal processor (DSP), network processor, or the like. The processing device 1202 is configured to execute instructions 1226 for performing the operations and steps discussed herein.

The computing device 1200 may further include a network interface device 1222 which may communicate with a network 1218. The computing device 1200 also may include a display device 1210 (e.g., a liquid crystal display (LCD) or a cathode ray tube (CRT)), an alphanumeric input device 1212 (e.g., a keyboard), a cursor control device 1214 (e.g., a mouse) and a signal generation device 1220 (e.g., a speaker). In at least one example, the display device 1210, the alphanumeric input device 1212, and the cursor control device 1214 may be combined into a single component or device (e.g., an LCD touch screen).

The data storage device 1216 may include a computer-readable storage medium 1224 on which is stored one or more sets of instructions 1226 embodying any one or more of the methods or functions described herein. The instructions 1226 may also reside, completely or at least partially, within the main memory 1204 and/or within the processing device 1202 during execution thereof by the computing device 1200, the main memory 1204 and the processing device 1202 also constituting computer-readable media. The instructions may further be transmitted or received over a network 1218 via the network interface device 1222.

While the computer-readable storage medium 1224 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to examples of the present disclosure.

### Example 1

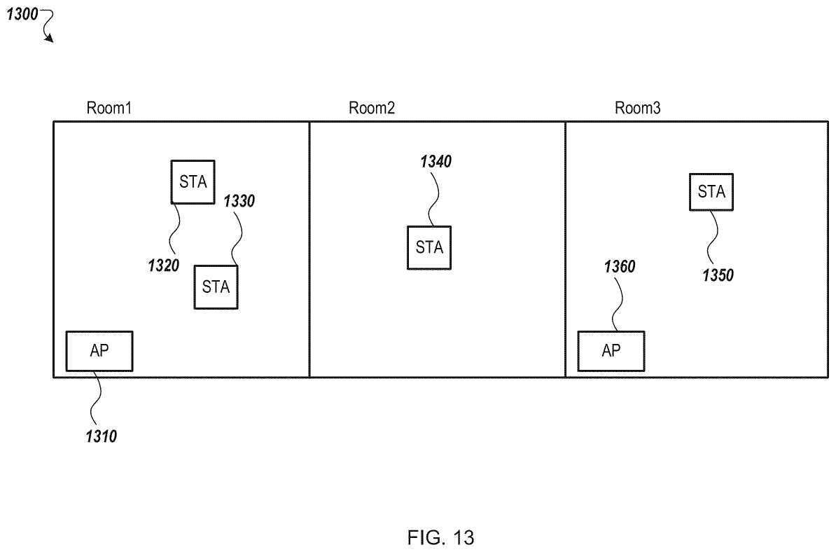

The following results show the performance of the presented methods. As illustrated in FIG. 13, 4 STAs 1320, 1330, 1340, 1350 are served simultaneously from 2 APs 1310, 1360 in a diagram 1300 having 3 rooms (Room 1, Room 2, Room3). 4 STAs are placed in various positions in the 3 rooms with a min. distance of 2 meters from the AP and on a 2 m×2 m grid. The reference cases represent the prior arts.

For the OBSS-case, the C-SR results have to be compared with the reference 3, where STAs are associated with 2 different APs and time multiplexing is performed between the STAs.

Reference cases: Reference 1 (BF): Beamforming and TDMA from one of the APs, 25% transmit time allocated to each of the 4 STAs. Reference 2 (MU MIMO): MU MIMO transmission serving 4 STAs simulataneously from 1 AP. Reference 3 (MU-MIMO 2): MU MIMO transmission serving 2 STAs simultaneously, while TDMA is performed between the APs.

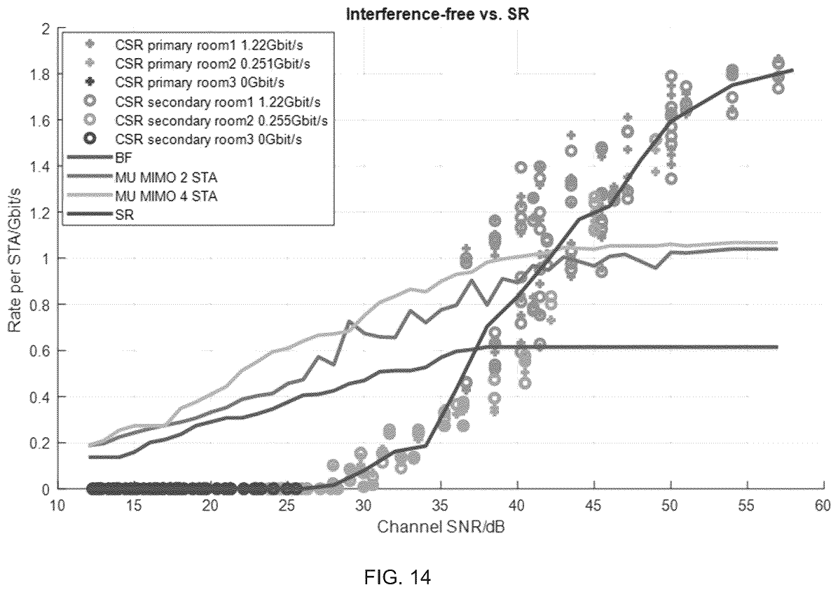

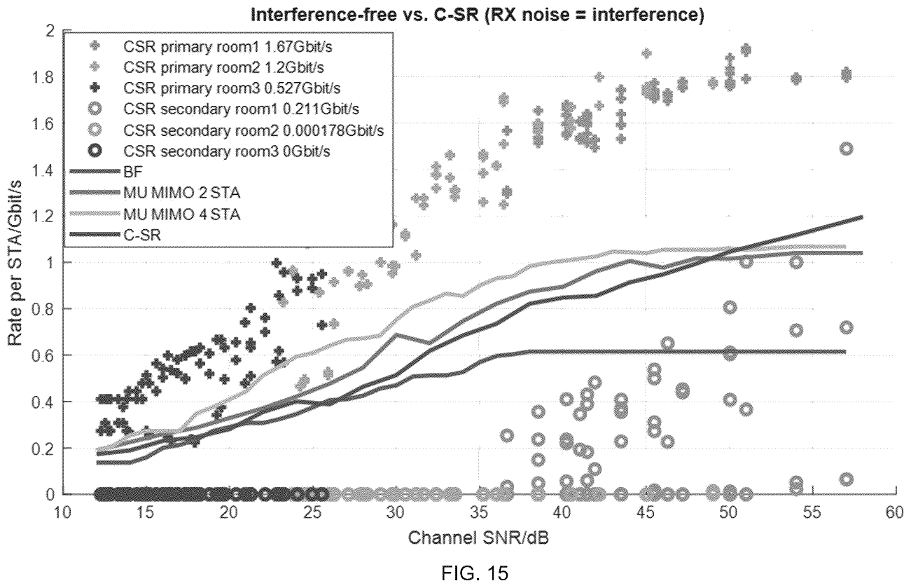

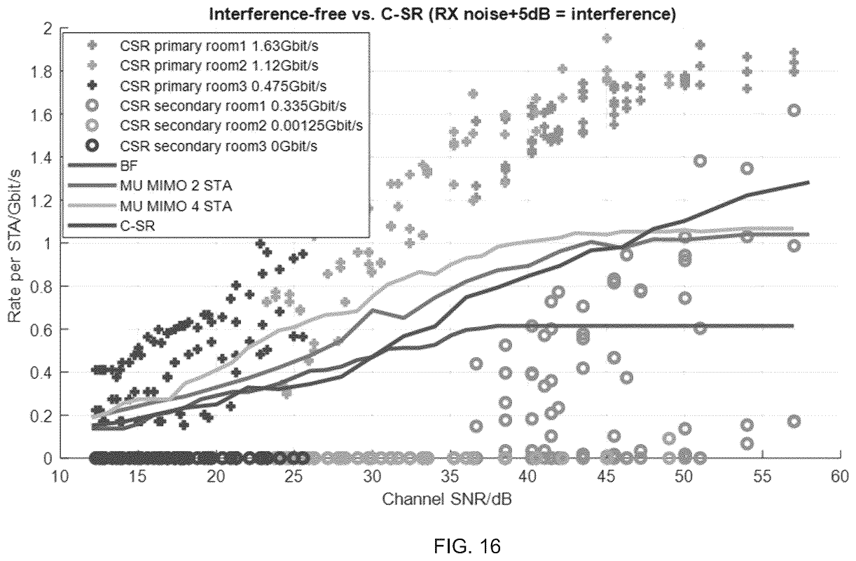

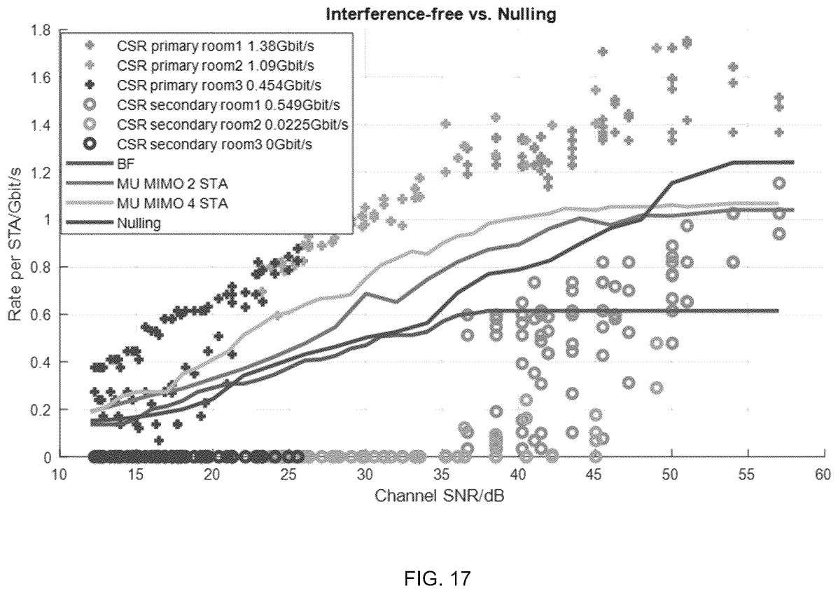

Test cases: Spatial re-use without coordination (FIG. 14). C-SR in OBSS without nulling capability, different acceptable interference levels (FIG. 15, FIG. 16). C-SR in OBSS with spatial nulling (FIG. 17).

### Example 2

FIG. 14 shows the rate-vs.-range of un-coordinated spatial re-use. Two APs transmit simultaneously to two STAs, each with the full transmit power. As long as all STAs are close to their associated AP, the rates are high. If not, the rates drop below the data rates achieved by crosstalk avoidance. This is not stable, as many STAs cannot be served at all.

### Example 3

FIG. 15 and FIG. 16 show the rate-vs.-range of coordinated spatial re-use. The primary AP transmits at full power. The secondary AP transmits with lower power, as required. The results show that the primary transmission is always successful, but with the primary data rates may drop due to the SNR decrease of up to 3 dB. While the rates seem lower, it must be noted that 20% (noise=interference) or 24% (noise+5 dB=interference) of the STAs enjoy a significantly reduced latency, as they are able to transmit at any time without interruption from another APs exclusive channel access.

### Example 4

FIG. 17 shows spatial nulling. This gives the highest data rates for the secondary channel. The penalty on the primary transmission is slightly higher, because the interference is present with higher probability. Furthermore, 38% of the STAs enjoy ultra low latency.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various examples of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP) comprising:
a processing device operable to:
receive, at the AP from a station (STA), coordinated spatial nulling (C-SN) feedback; and
determine, at the AP, a precoder based on the C-SN feedback; and
a transceiver operable to:
transmit, from the AP to the STA, a transmission using the precoder.

2. The access point of claim 1, wherein the processing device is further operable to:
receive, at the AP from an additional AP, sounding feedback; and
determine, at the AP, the precoder based on the sounding feedback.

3. The access point of claim 1, wherein the processing device is further operable to:
send, from the AP to an additional AP, the precoder in a precoder message.

4. The access point of claim 1, wherein the processing device is further operable to:
receive, at the AP from an additional STA, sounding feedback; and
determine, at the AP, the precoder based on the sounding feedback.

5. The access point of claim 4, wherein the additional STA is associated with the AP.

6. The access point of claim 1, wherein the C-SN feedback is provided by H_{sn,d→v}^{(k)}, wherein d is the AP and v is the STA.

7. The access point of claim 1, wherein the C-SN feedback is based on a threshold amount of one or more of noise or interference.

8. The access point of claim 1, wherein the AP is not associated with the STA.

9. A station (STA), comprising:
a processing device operable to:
send, from the STA to an access point (AP), coordinated spatial nulling (C-SN) feedback; and
a transceiver operable to:
receive, at the STA from the AP, a transmission using a precoder based on the C-SN feedback.

10. The STA of claim 9, wherein the processing device is further operable to:
send, from the STA to an additional AP, sounding feedback.

11. The STA of claim 9, wherein the C-SN feedback is provided by H_{sn,d→v}^{(k)}, wherein d is the AP and v is the STA.

12. The STA of claim 9, wherein the C-SN feedback is based on a threshold amount of one or more of noise or interference.

13. The STA of claim 9, wherein the AP is not associated with the STA.

14. A method, comprising:
receiving, at an access point (AP) from a station (STA), coordinated spatial nulling (C-SN) feedback;
determining, at the AP, a precoder based on the C-SN feedback; and
transmitting, from the AP to the STA, a transmission using the precoder.

15. The method of claim 14, further comprising:
receiving, at the AP from an additional AP, sounding feedback; and
determining, at the AP, the precoder based on the sounding feedback.

16. The method of claim 14, further comprising:
sending, from the AP to an additional AP, the precoder in a precoder message.

17. The method of claim 14, further comprising:
receiving, at the AP from an additional STA, sounding feedback; and
determining, at the AP, the precoder based on the sounding feedback.

18. The method of claim 14, wherein the C-SN feedback is provided by H_{sn,d→v}^{(k)}, wherein d is the AP and v is the STA.

19. The method of claim 14, wherein the C-SN feedback is based on a threshold amount of one or more of noise or interference.

20. The method of claim 14, wherein the AP is not associated with the STA.
